(19) United States
(12) Patent Application Publication
(10) Pub. No.: US 2011/0051325 A1
(43) Pub. Date: Mar. 3, 2011

(54) POWER SUPPLY SYSTEM

(76) Inventor: Michikata KAWASAKI, Gyoda-shi (JP)

(21) Appl. No.: 12/824,336

(22) Filed: Jun. 28, 2010

(30) Foreign Application Priority Data
Sep. 2, 2009 (JP) 2009-202295

(51) Int. Cl. H02B 1/04; H02J 3/04

(52) U.S. Cl. 361/631; 307/80

(57) ABSTRACT

The present invention provides a power supply system equipped with private power generation facilities suitable for use in general households and small-scale facilities and adapted to enable a reduction in power supply costs through easier operation. The power supply system is configured so as to include a master breaker connected to a commercial power source and branch breakers provided in branch electrical paths branched off from a trunk electrical path connected to the secondary side of the master breaker to supply electric power to respective electrical equipment, and configured by providing a changeover switch midway through the trunk electrical path and connecting a power generator to the changeover switch, so as to be able to select either commercial electricity or privately-generated electricity, wherein remotely-operable remote-control breakers are provided, along with the branch breakers, in the branch electrical paths, to form a load control unit, so that standby electricity can be cut off by opening/closing a desired remote breaker, no matter whether the system operates on commercial electricity or privately-generated electricity.

### BACKGROUND OF THE INVENTION

1. Field of the Invention

The present invention relates to a power supply system using electric power from private power generation facilities and electric power from a commercial power source.

2. Description of the Related Art

Various types of equipment have been developed as power supply systems for actuating private power generation facilities, such as a gas power generator or a diesel power generator, in case a commercial power source is cut off due to a disaster or an accident. For example, there is known a power supply system, like the one disclosed in Japanese Patent Laid-Open No. 2007-37222, wherein in a large-scale factory including both important loads for which the fluctuation of a power supply voltage is strictly controlled during use and general loads other than the important loads, electric power based on private power generation facilities supplied from a side for driving the important loads is also supplied to the general loads even in case of an unusual situation, such as the occurrence of thunder, thereby enabling the reduction of adverse effects on the general loads. This power supply system is intended for extra-high-voltage power consumers (large-scale factories), such as semiconductor factories. Such a semiconductor factory is equipped with private power generation facilities within the premises thereof as measures for ensuring a minimum voltage or measures against power cut due to thunder or the like. The power supply system of this related art includes: an interconnection bus for coupling a transmission system leading from a commercial power source with a transmission system installed within the premises; a circuit breaker connected to this interconnection bus; a general load connected to a local-area bus on the side thereof closer to the commercial transmission system side than the circuit breaker; an important load connected to the interconnection bus on the side thereof closer to the local-area transmission system side than the circuit breaker and stricter in voltage management than the general load; private power generation facilities installed within the premises; private power generation facilities for use as a standby power supply; and a power-feeding electrical path for supplying the power of the standby power supply to the general load, wherein when the circuit breaker is enabled, power from the standby power supply is supplied to the general load through the power-feeding electrical path.

In many cases, consumers in need of high-quality electric power free from power interruption and instantaneous voltage drops have had an uninterruptible power supply or private power generation facilities installed. In addition, a building or the like equipped with a host of information and communications equipment has the problem of loss of data at the equipment due to power interruption or voltage drops. In particular, the uninterruptible power supply facilities have to be unavoidably large in scale if power consumption at equipment in need of protection is large. Accordingly, the uninterruptible power supply facilities are, in some cases, used in combination with private power generation facilities. In general, the cost of power supply by the private power generation facilities is lower, compared with a case in which electricity is purchased from a general electric power supplier. However, since electric power consumed by a general consumer varies significantly between daytime and nighttime or with the seasons, the consumer needs to own many more power generation facilities to cope with peak loads, or set the maximum electricity demand contracted with the general electric power supplier to a larger value. In this case, owning private power generation facilities often has almost no effect of reducing power supply costs. Hence, there has been developed a power supply system, like the one disclosed in Japanese Patent Laid-Open No. 2004-32983, in which even if a consumer, whose variation of power consumption between daytime and nighttime or with the seasons is large, can reduce power supply costs. This power supply system successively gathers information on power consumption at load equipment, predicts electric power (demand) necessary at a predetermined time later on the basis of the gathered load-related information, and determines whether to operate or stop power generation facilities (determines the output of the facilities in the case of operation) in accordance with the prediction, so as to minimize power supply costs. In particular, by operating or stopping a plurality of power generation facilities in accordance with the load characteristics of the consumer, it is possible to hold down electricity purchased from a general electric power supplier through day and night and all seasons, thereby enabling economical power supply. In addition, by adding information on weather, temperature and the like to the gathered load-related information predicting electric power (demand) necessary at a predetermined time later, it is possible to predict necessary electric power suitable for environmental changes, such as weather and temperature changes. As the most important information gathering means, the patent document discloses the following: That is, the power supply system is configured by using means for determining the output of the power generation facilities when the facilities are put in operation as information gathering means, or by using means for determining a status change in the power generation facilities with power supply costs defined as an object function. In addition, a case is disclosed in which information on temperature and weather is gathered and the gathered information is used as learning data for predicting electric power necessary at a predetermined time later.

### SUMMARY OF THE INVENTION

Both of the techniques disclosed in Japanese Patent Laid-Open Nos. 2007-37222 and 2004-32983 are related to power supply systems used in combination with private power generation facilities. Unfortunately, however, these power supply systems are specifically intended for a large-scale factory, programs used therein for information gathering means are cumbersome and complicated, and the systems are costly as a whole. Hence, an object of the present invention is to provide a power supply system equipped with private power generation facilities suitable for use in general households and small-scale facilities and adapted to enable a reduction in power supply costs through easier operation.

In order to achieve the aforementioned object, a power supply system according to the present invention is equipped with a distribution switchboard including a master breaker connected to a commercial power source and branch breakers provided in branch electrical paths branched off from a trunk electrical path connected to the secondary side of the master breaker to supply electric power to respective electrical equipment, and is configured by providing a changeover switch midway through the trunk electrical path and connecting a power generator to this changeover switch, so as to be able to select either commercial electricity or privately-generated electricity, wherein remotely-operable remote-control breakers are provided, along with the branch breakers, in electrical paths, among the plurality of the branch electrical paths, connected to electric equipment for which standby electricity is allowed to be cut off, to form a load control unit, and the current values of the branch electrical paths in which these remote-control breakers are provided are detected to verify a state of standby electricity consumption by predetermined electrical equipment and operate a desired remote breaker, thereby cutting off the standby electricity.

According to the present invention, a power supply system is equipped with a distribution switchboard including a master breaker connected to a commercial power source and branch breakers provided in branch electrical paths branched off from a trunk electrical path connected to the secondary side of this master breaker to supply electric power to respective electrical equipment, and is configured by providing a changeover switch midway through the trunk electrical path and connecting a power generator to this changeover switch, so as to be able to select either commercial electricity or privately-generated electricity, wherein remotely-operable remote-control breakers are provided, along with the branch breakers, in electrical paths, among the plurality of the branch electrical paths, connected to electric equipment for which standby electricity is allowed to be cut off, to form a load control unit, and the current values of the branch electrical paths in which these remote-control breakers are provided are detected to verify a state of standby electricity consumption by predetermined electrical equipment and operate a desired remote breaker, thereby cutting off the standby electricity. Consequently, anyone, including ordinary housewives and elderly persons, can save power by means of simple operation, no matter whether the electrical equipment operates on commercial electricity or on privately-generated electricity. In addition, it is possible to install the power supply system at low cost by using an existing distribution switchboard and effectively utilize the system in a time of disaster or the like.

### BRIEF DESCRIPTION OF THE DRAWINGS

FIG. 1 is a schematic view illustrating the overall configuration of a system of the present invention;

FIG. 2 is a block diagram illustrating an operation system of the system of the present invention;

FIG. 3 is a flowchart showing an operating procedure of the system of the present invention;

FIG. 4 is a schematic view illustrating LP gas-driven power generation facilities;

FIG. 5 is a circuit diagram illustrating a specific embodiment of the present invention;

FIG. 6 is a detailed flowchart used in case of power interruption; and

FIG. 7 is a flowchart at the time of trial operation of power generation facilities.

### DETAILED DESCRIPTION OF THE PREFERRED EMBODIMENTS

Hereinafter, embodiments of the present invention will be described with reference to the accompanying drawings.

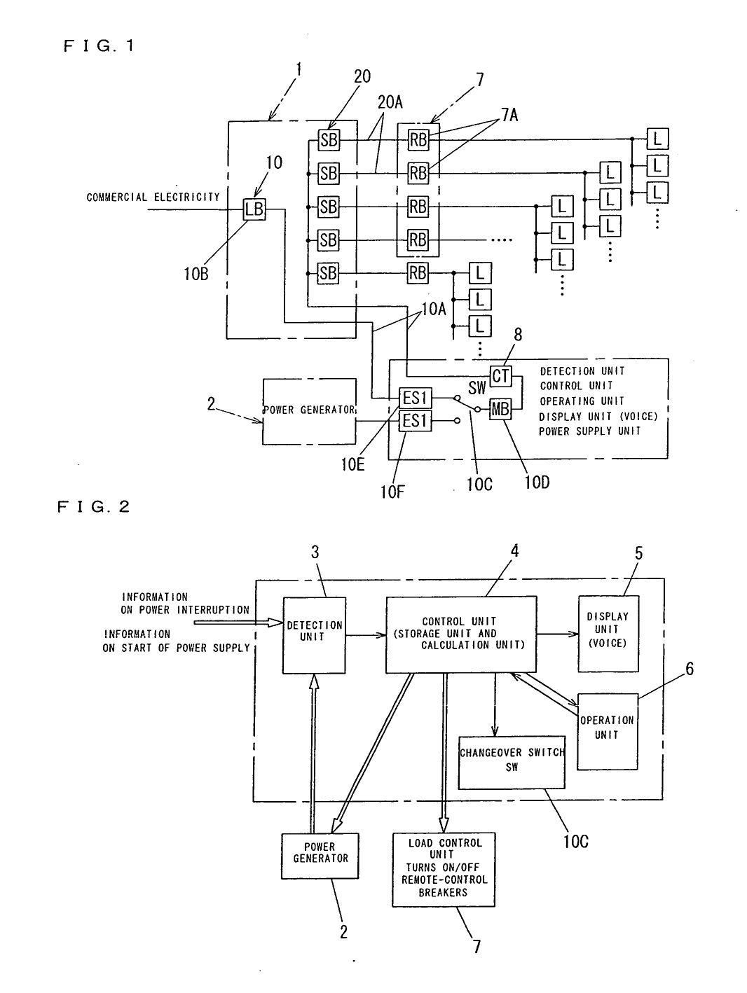

FIG. 1 illustrates the overall configuration of a system of the present invention. The system is equipped with a distribution switchboard 1 including a master breaker 10 connected to a commercial power source and branch breakers 20 (denoted by SB) provided in branch electrical paths 20A branched off from a trunk electrical path 10A connected to the secondary side of the master breaker 10 to supply electric power to respective electrical equipment. For this distribution switchboard 1, an existing distribution switchboard is used. A plurality of loads L, such as outlets and lighting equipment, are respectively connected to the branch electrical paths 20A, and electrical equipment are provided as these loads L.

A breaker for power contract (LB) 10B is provided at the beginning of the trunk electrical path 10A and a changeover switch (SW) 100 is provided midway therethrough. A main breaker (MB) 10D is connected to this changeover switch 10C. Commercial electricity flows through the trunk electrical path 10A by way of the breaker for power contract 10B. When the changeover switch 100 is connected to the commercial electricity side through a first voltage relay 10E, the commercial electricity flows through the branch electrical paths 20A if the main breaker 10D is open. A power generator 2 of private power generation facilities is connected to the changeover switch 10c through a second voltage relay 10F. By switching this changeover switch 100, electricity supplied from the power generator 2 is caused to pass through the second voltage relay 10F and the main breaker 10D and flow from the trunk electrical path 10A to the branch electrical paths 20A and the loads L.

A detection unit 3, a control unit 4, a display unit 5, an operating unit 6, and the like to be described later are arranged in a location where the changeover switch 100 and the main breaker 10D are installed. A load measuring current transformer 8 is provided midway through the trunk electrical path 10A connecting the main breaker 10D and the branch breakers 20. In addition, there is formed a load control unit 7 in which remotely-operable remote-control breakers (RB) 7A are arranged in electrical paths, among the branch electrical paths 20A, connected to electrical equipment for which standby electricity is allowed to be cut off. By switching the remote-control breakers 7A of this load control unit 7 through the operation of an operating unit 6 to be described later, it is possible to turn on or cut off power to the loads L. This load control unit 7 is preferably not accommodated in the cabinet of an existing distribution switchboard 1 but is provided as a subordinate distribution switchboard inside a separately installed cabinet. For example, if the loads L include loads L₁ to L₁₀, remote breakers 7A are provided between the loads L₁ to L₅ and five branch breakers 20, among ten branch breakers 20 of the existing distribution switchboard 1, connecting from the branch electrical paths 20A to the loads L₁ to L₅ (subject to standby electricity cutoff), and these remote breakers 7A are accommodated in the separately installed cabinet. This configuration makes it possible, through simple work, to individually cut off standby electricity supplied to each load L in need of cutoff, which has not been possible with the existing distribution switchboard.

In a conventional private house or a collective house, lighting equipment in each room is usually turned off when residents go out of the house or go to bed. However, electrical equipment, such as television sets, video cassette recorders, air-conditioners, and cleaning apparatus attached to toilet bowls, remain plugged into outlets, and therefore, standby electricity continues to be consumed. Standby electricity can be saved if the switches of branch breakers in a distribution switchboard by which electricity is distributed to respective rooms of the house are turned off. As it stands now, however, almost no one takes the trouble to turn off the breakers of the distribution switchboard. The present invention makes it possible to turn on/off the remote breakers 7A of the load control unit 7 by means of remote operation using the operating unit 6 to be described later. Consequently, it is possible to save standby electricity used in a circuit of specific loads L, no matter whether a commercial power source or the power generator 2 is used. In addition, when the main breaker 10D is placed in a state of cutoff, electricity does not flow through the branch electrical paths 20A at all, no matter whether the electricity is commercial electricity or privately-generated electricity. Thus, it is possible to cut off power to all of the loads L. Furthermore, by enabling the changeover switch 10C to be also turned on/off through the operation of the operating unit 6 and determining whether or not to start the operation of the power generator 2 according to a user's estimate of the situation, it is possible to reduce the waste of fuel of the power generator 2 (diesel oil or gas). The system is previously configured, so that when a recovery is made from power interruption and commercial electricity once again becomes available, circuit switching is automatically performed to stop the power generator 2.

FIG. 2 is a block diagram illustrating an operation system of the present invention. The detection unit 3 detects information on the interruption and start of supply of a commercial power source (voltage at the main breaker 10D may be detected using an appropriate sensor) and on the remaining fuel, temperature, voltage, and the like of the power generator 2. This detected information, i.e., information on the power generator 2, information on the voltage detection of the commercial power source, information on the usage detection of currents supplied to the loads L, and the like, are sent to a control unit (CPU) 4. These information items are stored and calculated in the control unit 4. The information processed in this control unit 4 is displayed on a display unit 5. As the display unit 5, a touch-sensitive panel is used. As information to be displayed, the display unit constantly shows the load current values (amperes) of the branch electrical paths 20A and percentages (%) with respect to set values. Previously inputting a maximum current value at the time of initial setup causes the display unit to show a ratio of the value of a current presently flowing through a particular branch electrical path 20A to the maximum current value. Information on the power generator 2 is displayed on the display unit 5 only if an alarm needs to be given, for example, if the fuel of the power generator is low. In addition, the display unit 5 displays information also at the time of power interruption and when the power generator 2 is in operation. That is, the display unit 5 displays the on/off states of the remote breakers 7A of the load control unit 7, preprogrammed several messages as to whether the system is in power-saving mode or normal mode, and the date and time. Note that information may preferably be provided by means of not only visual displays but also voice. Also note that the operating history, operational failure history, alarm history, and the like of the power generator 2 are also stored, so that these information items can be displayed, as necessary, on the display unit 5.

The operating unit 6 connected to the control unit 4, if formed into a touch-sensitive panel, becomes an integral component of the display unit 5. Thus, the operating unit 6 is configured to display several types of power-saving mode instruction buttons, system-by-system individual energization instruction buttons (locations denoted by RB), instruction buttons for the start/stop of the power generator 2, and the like. By selecting a button from among these buttons and pressing the button, the changeover switch 100 is opened/closed from the control unit 4, the load control unit 7 is controlled, power to the power generator 2 is turned on/off, or the starter thereof is actuated.

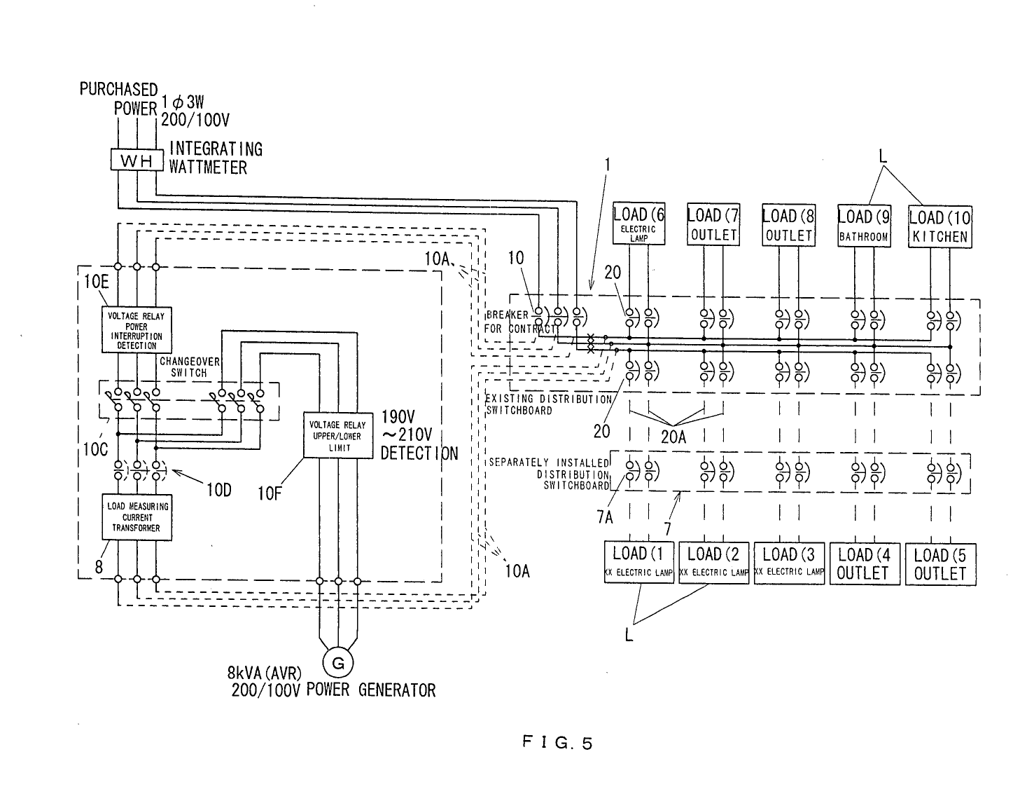

For control by the load control unit 7, current sensors, such as CT clamps (current detection means), are arranged in the branch electrical paths 20A in which the remote breakers 7A are provided. Using these sensors, current values are constantly sensed, the current values are displayed on the display unit 5, remote-control functions within the control unit 4 are enabled, i.e., signals are sent to the remote breakers 7A to open/close the breakers, specific remote breakers 7A are turned off, and standby electricity is cut off. If loads L to be controlled are the earlier-mentioned five loads L₁ to L₅ (see loads (1 to (5 in FIG. 5), a mode for cutting off standby electricity to all of the loads is preprogrammed as M₁, a mode for cutting off standby electricity to four of the loads is preprogrammed as M₂, and a mode for cutting off standby electricity to three of the loads is preprogrammed as M₃. Consequently, by selecting each of the M₁ to M₃ buttons of the operating unit 6, it is possible to select a power-saving mode that a user needs. It is also possible to previously configure the system, so that combinations of the loads L₁ to L₅, for which standby electricity should be manually cut off, can be programmed.

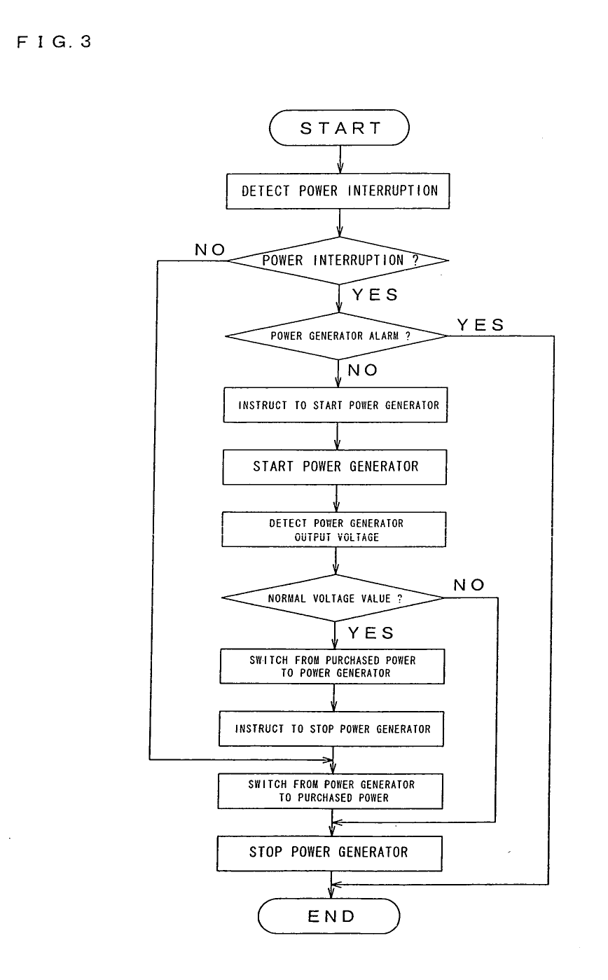

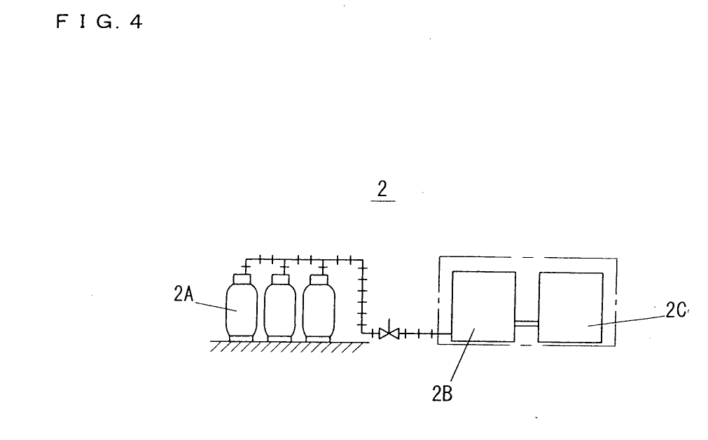

By way of explanation of the operating procedure of the present system according to the flowchart of FIG. 3, a detection is made by a sensor as to whether or not commercial electricity is interrupted; the operation of the power generator 2 is started manually in case of power interruption; information on the power generator 2 is made known prior to an instruction to operate the generator; a determination is made as to whether or not an alarm is given to warn that the fuel is almost exhausted; and the operation of the power generator is started with no alarms given. The voltage of the power generator 2 is detected when the power generator 2 is started. If the value of the voltage is normal, an electrical path on the power generator 2 side and a trunk electrical path 10A leading to the branch electrical paths 20A are connected to each other by the changeover switch 10C. Also in a state of this private power generation facilities kept in operation, it is possible to control the load control unit 7 and set a power-saving mode. Thereafter, when a recovery is made from power interruption and commercial electricity is restored, the power generator 2 is stopped to switch to the commercial electricity.

As the power generator 2, an LP gas power generator is preferred. For example, the power generator is configured so that, as illustrated in FIG. 4, an LP gas is sent from an LP gas cylinder 2A to an engine motor 2B and a power generating unit 2C is actuated by this motor 2B to generate electricity. Sensors for flow rate detection, pressure detection and stored gas quantity detection are provided in a location where the LP gas cylinder 2A is installed. Sensors for engine oil level detection, engine enclosure temperature detection, generated voltage detection, power generation frequency detection, and battery voltage detection are provided in a location where electricity is generated. If the power generator 2 uses a city gas, a prolonged period of time may be taken for the city gas to recover in a time of disaster or the like. Thus, there arises the situation that the power generator cannot be operated when the private power generation facilities are desired to be operated. If the power generator 2 uses diesel oil, it may be difficult to obtain the oil since gas stations may fail to function. If the power generator 2 uses an LP gas, it is possible to store gas cylinders in reserve and immediately put the power generator in operation even in case of a disaster. In addition, it is possible to save power also during LP gas-based power generation. Accordingly, it is possible to supply a necessary and sufficient amount of electricity for a certain period of time until recovery. Furthermore, as the power generator 2, it is also possible to use one utilizing solar light. For example, configuring the power generator as a power source capable of utilizing a solar-powered lithium-ion battery during steady-state operation is environmentally-friendly, and therefore, preferable from a power-saving point of view.

FIG. 5 illustrates a specific circuit diagram. As loads L, the switches (RB) of electric lamps and outlets in a certain room (shown as loads (1 to (5 in the figure) are provided in a separately installed distribution switchboard, so as to be turned on/off according to a previously-set power-saving program. Standby electricity is cut off by turning off these switches of the load control unit 7, i.e., the remote-control breakers 7A.

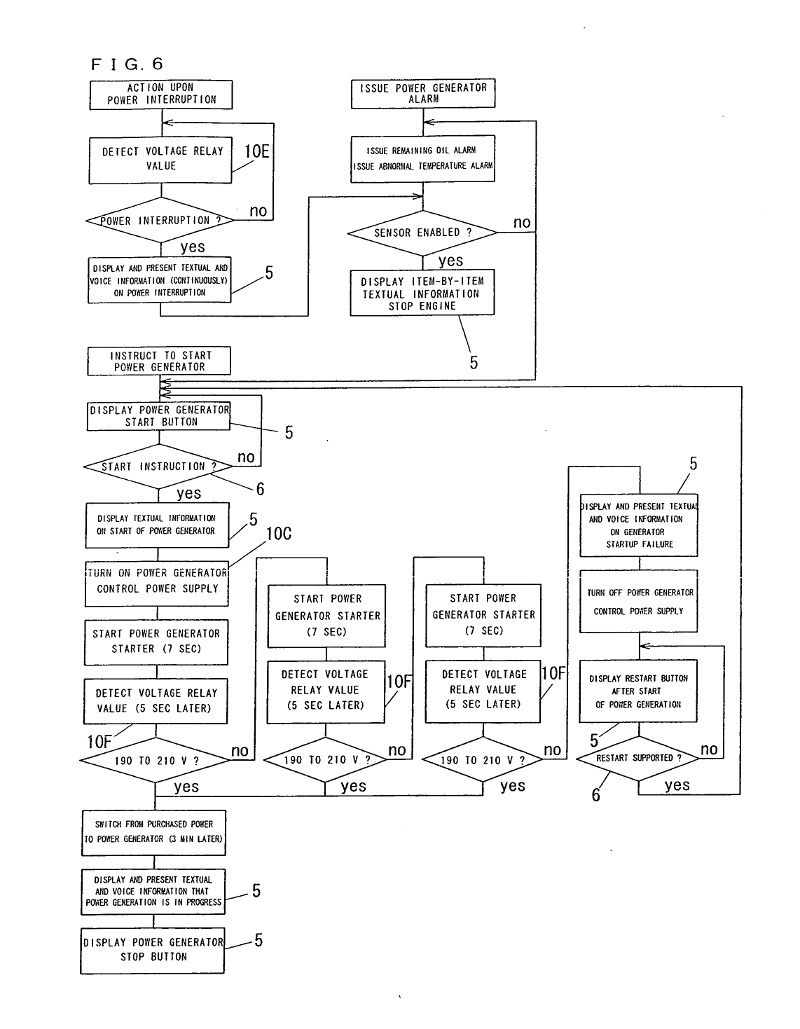

FIG. 6 illustrates an even more detailed flowchart used at the time of power interruption. The system is configured so that the occurrence of power interruption is notified also by means of voice at the display unit 5. In this example, the operation of the power generator 2 is performed by operating buttons of the operating unit 6. Alternatively, however, cases may be considered in which the power generator 2 is automatically put in operation simultaneously with power interruption. For example, the power generator can previously be configured, so as to be automatically put in operation in such a place as a hospital or a public institution. An inspection is made whether or not there are any problems with the power generator 2 before the start button of the power generator 2 is displayed on the display unit 5. That is, the system detects whether or not a sensor on the power generator 2 side has sensed any failure when the occurrence of power interruption is notified by means of textual and voice information. Thus, it is possible to press a button of the operating unit 6 with the power generator 2 free of any anomalies (the remaining amount of oil is sufficient and there is no temperature rise). When the start button is pressed, a generator control power supply is turned on as the result of the changeover switch 100 being switched. Thus, the starter of the power generator 2 is actuated, and a switch is made from commercial electricity to the power generator 2 through a voltage relay 10F. Using the display unit 5, the system annunciates, by means of textual and voice information, that the power generator 2 is generating electricity. At this time, a stop button of the power generator 2 is displayed on the display unit 5. If a predetermined voltage proves not applied at the time of voltage detection by the voltage relay 10F, the starter of the power generator 2 is restarted as many times as twice. If the system fails to start the power generator 2 twice in a row, a notification of operation failure is given by means of textual and voice information. The control power supply of the power generator 2 is cut off. If, at this point, a restart button of the display unit 5 is pressed to instruct restart and no failure is found in the power generator 2, the power generator 2 can be put in operation.

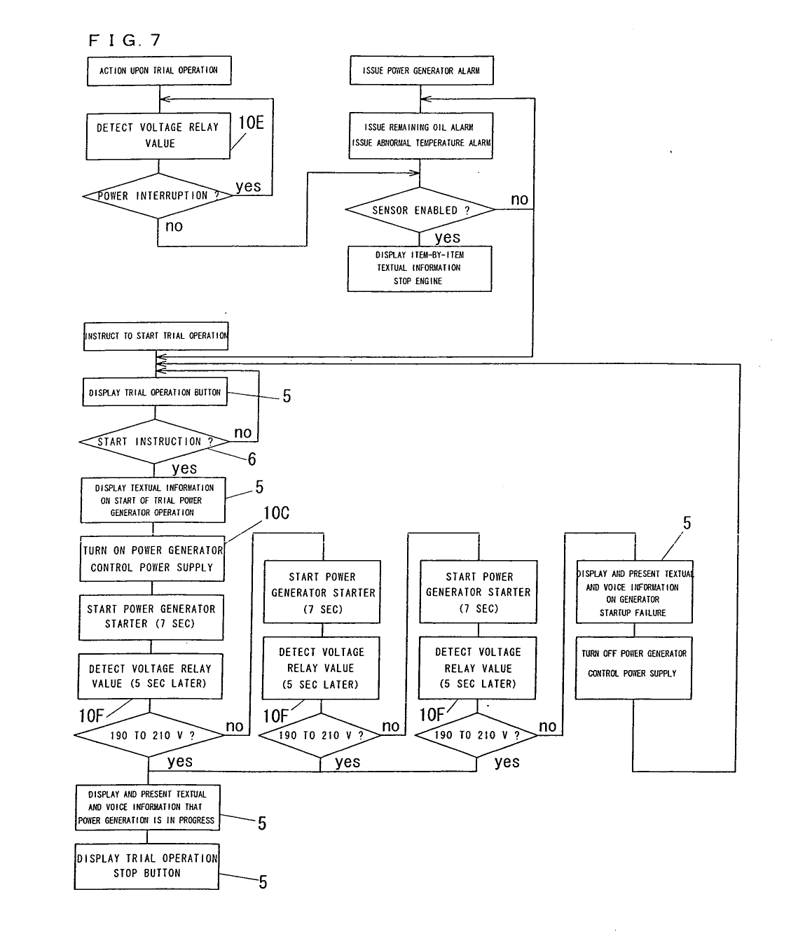

FIG. 7 illustrates a flowchart used for the trial operation of the power generator 2. It is extremely important to do the maintenance work of the power generator 2 by performing trial operation about once every two weeks. Failure to do such maintenance work (trial operation) may give rise to the situation that the power generator 2 fails to operate in case a disaster actually occurs. When the system detects, through a voltage relay 10E, that there is no power interruption and verifies that no problems are found in the power generator 2, a trial operation button is displayed on the display unit. Pressing this button causes the display unit to show a message of trial operation and the power generator 2 begins to operate in the same way as described above. The display unit also informs accordingly by means of voice. If the predetermined voltage is not detected at the voltage relay 10F, the system repeats the same action several times. If the voltage is detected, the power generator 2 begins to operate.

What is claimed is:

1. A power supply system equipped with a distribution switchboard including a master breaker connected to a commercial power source and branch breakers provided in branch electrical paths branched off from a trunk electrical path connected to the secondary side of the master breaker to supply electric power to respective electrical equipment, and configured by providing a changeover switch midway through the trunk electrical path and connecting a power generator to the changeover switch, so as to be able to select either commercial electricity or privately-generated electricity, wherein remotely-operable remote-control breakers are provided, along with the branch breakers, in electrical paths, among the plurality of the branch electrical paths, connected to electric equipment for which standby electricity is allowed to be cut off, to form a load control unit, and the current values of the branch electrical paths in which the remote-control breakers are provided are detected to verify a state of standby electricity consumption by predetermined electrical equipment and operate a desired remote breaker, thereby cutting off the standby electricity.

2. The power supply system according to claim 1, wherein the load control unit in which the remote-control breakers are arranged is provided as a subordinate distribution switchboard separately installed from the distribution switchboard.
